(19) United States
(12) Patent Application Publication
(10) Pub. No.: US 2005/0238113 A1
(43) Pub. Date: Oct. 27, 2005

(54) Hybrid communication method and apparatus

(76) Inventors: John Santhoff, Carlsbad, CA (US); Kazimierz Siwiak, Coral Springs, FL (US)

Correspondence Address: PULSE-LINK, INC., 1969 KELLOGG AVENUE, CARLSBAD, CA, 92008, US

(21) Appl. No.: 10/832,868

(22) Filed: Apr. 26, 2004

(51) Int. Cl. H04L 27/20; H04L 27/30; H04L 27/12

(52) U.S. Cl. 375/295

(57) ABSTRACT

The present invention enables communication between devices employing different communication technologies. One embodiment of the present invention is a hybrid communication device that can transmit and receive both conventional carrier wave signals, and ultra-wideband pulses. Another embodiment of the present invention is a hybrid communication device that can transmit and receive different ultra-wideband communication implementations, or protocols. Another embodiment of the present invention provides a method of communication with a hybrid communication device comprising transmitting an ultra-wideband signal and a conventional carrier wave signal. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention relates generally to the field of communications. More particularly, the present invention relates to a hybrid communication device for wireless and/or wire media.

### BACKGROUND OF THE INVENTION

The Information Age is upon us. Access to vast quantities of information through a variety of different communication systems are changing the way people work, entertain themselves, and communicate with each other.

For example, because of the 1996 Telecommunications Reform Act, traditional cable television program providers have now evolved into full-service providers of advanced video, voice and data services for homes and businesses. A number of competing cable companies now offer cable systems that deliver all of the just-described services via a single broadband network.

These services have increased the need for bandwidth, which is the amount of data transmitted or received per unit time. More bandwidth has become increasingly important, as the size of data transmissions has continually grown. Applications such as in-home movies-on-demand and video teleconferencing demand high data transmission rates. Another example is interactive video in homes and offices.

Other industries are also placing bandwidth demands on Internet service providers, and other data providers. For example, hospitals transmit images of X-rays and CAT scans to remotely located physicians. Such transmissions require significant bandwidth to transmit the large data files in a reasonable amount of time. These large data files, as well as the large data files that provide real-time home video are simply too large to be feasibly transmitted without an increase in system bandwidth. The need for more bandwidth is evidenced by user complaints of slow Internet access and dropped data links that are symptomatic of network overload.

In addition, the wireless device industry has recently seen unprecedented growth. With the growth of this industry, communication between different wireless devices has become increasingly important. Conventional radio frequency (RF) technology has been the predominant technology for wireless device communication for decades.

Conventional RF technology employs continuous carrier sine waves that are transmitted with data embedded in the modulation of the sine waves' amplitude or frequency. For example, a conventional cellular phone must operate at a particular frequency band of a particular width in the total frequency spectrum. Specifically, in the United States, the Federal Communications Commission (FCC) has allocated cellular phone communications in the 800 to 900 MHz band. Generally, cellular phone operators divide the allocated band into 25 MHz portions, with selected portions transmitting cellular phone signals, and other portions receiving cellular phone signals.

Another type of inter-device communication technology is ultra-wideband (UWB). UWB technology employs discrete pulses of electromagnetic energy and is fundamentally different from conventional carrier wave RF technology. UWB generally employs a “carrier free” architecture, which does not necessarily require the use of high frequency carrier generation hardware, carrier modulation hardware, frequency and phase discrimination hardware or other devices employed in conventional frequency domain communication systems.

One feature of UWB is that a UWB signal, or pulse, may occupy a very large amount of RF spectrum, for example, generally in the order of gigahertz of frequency band. Currently, the FCC has allocated the RF spectrum located between 3.1 gigahertz and 10.6 gigahertz for UWB communications. The FCC has also mandated that UWB signals, or pulses must occupy a minimum of 500 megahertz of RF spectrum.

Developers of UWB communication devices have proposed different architectures, or communication methods for ultra-wideband devices. In one approach, the available RF spectrum is partitioned into discrete frequency bands. A UWB device may then transmit signals within one or more of these discrete sub-bands. Alternatively, a UWB communication device may occupy all, or substantially all, of the RF spectrum allocated for UWB communications.

With the development of UWB communications, and the continual deployment of new devices that use conventional carrier wave technology, a need exists for a hybrid communication device.

### SUMMARY OF THE INVENTION

The present invention provides systems and methods that enable communication between devices employing different communication technologies, such as ultra-wideband and conventional carrier wave technologies. Several different embodiments of the present invention are disclosed. One embodiment of the present invention is a hybrid communication device that can transmit and receive both conventional carrier wave signals, and ultra-wideband pulses. Another embodiment of the present invention is a hybrid communication device comprising a transceiver that can send and receive pulses from different types of ultra-wideband communication technology signals. Yet another embodiment of the present invention is a hybrid communication device comprising a transceiver that can send and receive pulses from different types of ultra-wideband communication technology signals, as well as conventional carrier wave signals.

One embodiment of the hybrid communication device comprises two signal generators. One signal generator may be configured to generate ultra-wideband pulses, and the other signal generator may be configured to generate a conventional carrier wave communication signal.

Another embodiment of the present invention provides a method of communication with a hybrid communication device comprising transmitting an ultra-wideband signal and a conventional carrier wave signal. Both signals may be transmitted simultaneously, or alternatively, they may be transmitted consecutively. One feature of this embodiment is that the conventional carrier wave signal may provide synchronization between communicating devices.

These and other features and advantages of the present invention will be appreciated from review of the following detailed description of the invention, along with the accompanying figures in which like reference numerals refer to like parts throughout.

### BRIEF DESCRIPTION OF THE DRAWING

FIG. 1 is an illustration of different communication methods;

FIG. 2 is an illustration of two ultra-wideband pulses;

FIG. 3 is a chart of ultra-wideband emission limits as established by the Federal Communications Commission on Apr. 22, 2002;

FIG. 4 is a chart of emission limits for unlicensed National Information Infrastructure (U-NII) devices, as established by the Federal Communications Commission on Nov. 18, 2003;

FIG. 5 is a block diagram of a hybrid communication device comprising one embodiment of the present invention;

FIGS. 6A-C illustrate three different signal generating methods constructed according to three different embodiments of the present invention;

FIG. 7 is an illustrative chart that includes both the FIG. 3 ultra-wideband emission limits and the FIG. 4U-NII emission limits;

FIG. 8 illustrates the frequency spectrum that may be occupied, in whole or in part, by ultra-wideband pulses transmitted by the hybrid communication device shown in FIG. 5;

FIG. 9 illustrates the frequency spectrum that may be occupied, in whole or in part, by electromagnetic pulses or conventional carrier wave signals transmitted by the hybrid communication device shown in FIG. 5;

FIG. 10 illustrates the frequency spectrum that may be occupied, in whole or in part, by electromagnetic pulses or conventional carrier wave signals transmitted by the hybrid communication device shown in FIG. 5;

FIGS. 11A-B illustrate second and third embodiments of the hybrid communication device shown in FIG. 5;

FIGS. 12A-B illustrate fourth and fifth embodiments of the hybrid communication device shown in FIG. 5;

FIG. 13 illustrates one embodiment of a transmitter and a receiver as included within the fourth and fifth embodiments of the hybrid communication device shown in FIGS. 12A-B; and

FIG. 14 illustrates one method of communication constructed according to the present invention.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a system, method, and apparatus for wireless communication in a wireless or wire medium. In one embodiment of the present invention, a communication device comprises two signal generation sections. One signal generation section generates ultra-wideband pulses, or signals and the other generates non-ultra-wideband signals, such as conventional carrier wave, or substantially continuous sinusoidal signals. The communication device of the present invention also includes a transmitter section, a receiver section, and a computer controller.

One communication method of the present invention comprises transmitting an ultra-wideband pulse, or signal and a conventional carrier wave signal. Both signals may be transmitted simultaneously, or alternatively, they may be transmitted exclusively of each other. One feature of this embodiment is that the conventional carrier wave signal may provide synchronization between communicating devices. One feature of this method is that the non-ultra-wideband signal may be transmitted at a substantially higher power than the ultra-wideband pulse, or signal allowing for greater communication distances. Another feature of the present invention is that the non-ultra-wideband signal may be used to employ a common communication, or signaling protocol that enables communication between dissimilar communication devices.

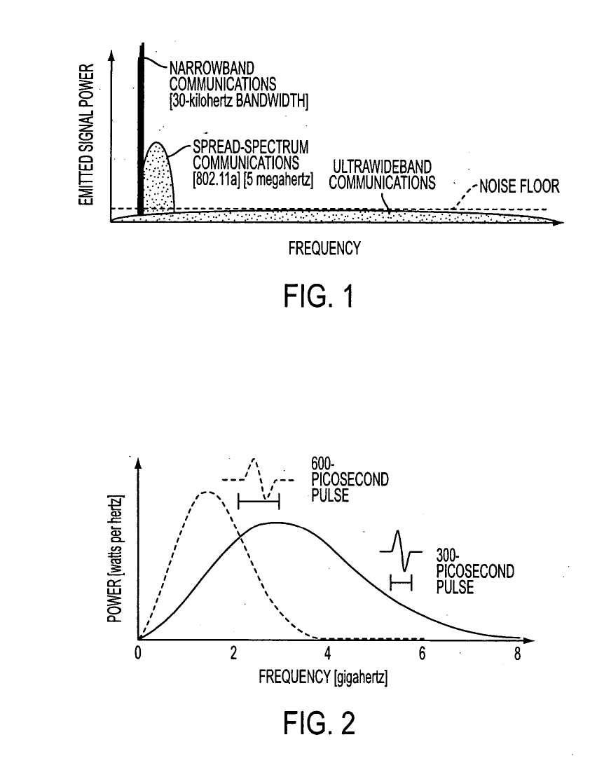

Referring to FIGS. 1 and 2, ultra-wideband (UWB) communication employs discrete pulses of electromagnetic energy that are emitted at, for example, nanosecond or picosecond intervals (generally tens of picoseconds to a few nanoseconds in duration). For this reason, ultra-wideband is often called “impulse radio.” That is, the UWB pulses may be transmitted without modulation onto a sine wave, or a sinusoidal carrier, in contrast with conventional carrier wave communication technology. UWB generally requires neither an assigned frequency nor a power amplifier.

Alternate embodiments of UWB may be achieved by mixing baseband pulses (i.e., information-carrying pulses), with a carrier wave that controls a center frequency of a resulting signal. The resulting signal is then transmitted using discrete pulses of electromagnetic energy, as opposed to transmitting a substantially continuous sinusoidal signal.

An example of a conventional carrier wave communication technology is illustrated in FIG. 1. IEEE 802.11a is a wireless local area network (LAN) protocol, which transmits a sinusoidal radio frequency signal at a 5 GHz center frequency, with a radio frequency spread of about 5 MHz. As defined herein, a carrier wave is an electromagnetic wave of a specified frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (5 MHz) that has a duration that may range from seconds to minutes.

In contrast, an ultra-wideband (UWB) pulse may have a 2.0 GHz center frequency, with a frequency spread of approximately 4 GHz, as shown in FIG. 2, which illustrates two typical UWB pulses. FIG. 2 illustrates that the shorter the UWB pulse in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.2 GHz. Thus, UWB pulses generally do not operate within a specific frequency, as shown in FIG. 1. Either of the pulses shown in FIG. 2 may be frequency shifted, for example, by using heterodyning, to have essentially the same bandwidth but centered at any desired frequency. And because UWB pulses are spread across an extremely wide frequency range, UWB communication systems allow communications at very high data rates, such as 100 megabits per second or greater.

Further details of UWB technology are disclosed in U.S. Pat. No. 3,728,632 (in the name of Gerald F. Ross, and titled: Transmission and Reception System for Generating and Receiving Base-Band Duration Pulse Signals without Distortion for Short Base-Band Pulse Communication System), which is referred to and incorporated herein in its entirety by reference.

Also, because the UWB pulses are spread across an extremely wide frequency range, the power sampled in, for example, a one megahertz bandwidth, is very low. For example, UWB pulses of one nano-second duration and one milliwatt average power (0 dBm) spreads the power over the entire one gigahertz frequency band occupied by the pulse. The resulting power density is thus 1 milliwatt divided by the 1,000 MHz pulse bandwidth, or 0.001 milliwatt per megahertz (−30 dBm/MHz). This is below the signal level of any wire media system and therefore does not interfere with the demodulation and recovery of signals transmitted by the CATV provider.

Generally, in the case of wireless communications, a multiplicity of UWB pulses may be transmitted at relatively low power density (milliwatts per megahertz). However, an alternative UWB communication system may transmit at a higher power density. For example, UWB pulses may be transmitted between 30 dBm to −50 dBm.

UWB pulses, however, transmitted through many wire media will not interfere with wireless radio frequency transmissions. Therefore, the power (sampled at a single frequency) of UWB pulses transmitted though wire media may range from about +30 dBm to about −140 dBm.

The present invention may be employed in any type of network, be it wireless, wire, or a mix of wire media and wireless components. That is, a network may use both wire media, such as coaxial cable, and wireless devices, such as satellites, or cellular antennas. As defined herein, a network is a group of points or nodes connected by communication paths. The communication paths may use wires or they may be wireless. A network as defined herein can interconnect with other networks and contain sub-networks. A network as defined herein can be characterized in terms of a spatial distance, for example, such as a local area network (LAN), a personal area network (PAN), a metropolitan area network (MAN), a wide area network (WAN), and a wireless personal area network (WPAN), among others. A network as defined herein can also be characterized by the type of data transmission technology used by the network, such as, for example, a Transmission Control Protocol/Internet Protocol (TCP/IP) network, a Systems Network Architecture network, among others. A network as defined herein can also be characterized by whether it carries voice, data, or both kinds of signals. A network as defined herein may also be characterized by users of the network, such as, for example, users of a public switched telephone network (PSTN) or other type of public network, and private networks (such as within a single room or home), among others. A network as defined herein can also be characterized by the usual nature of its connections, for example, a dial-up network, a switched network, a dedicated network, and a non-switched network, among others. A network as defined herein can also be characterized by the types of physical links that it employs, for example, optical fiber, coaxial cable, a mix of both, unshielded twisted pair, and shielded twisted pair, among others.

The present invention may be employed in any type of wireless network, such as a wireless PAN, LAN, MAN, or WAN. In addition, the present invention may be employed in wire media, as the present invention dramatically increases the bandwidth of conventional networks that employ wire media, yet it can be inexpensively deployed without extensive modification to the existing wire media network.

Several different methods of ultra-wideband (UWB) communications have been proposed. For wireless UWB communications in the United States, all of these methods must meet the constraints recently established by the Federal Communications Commission (FCC) in their Report and Order issued Apr. 22, 2002 (ET Docket 98-153). Currently, the FCC is allowing limited UWB communications, but as UWB systems are deployed, and additional experience with this new technology is gained, the FCC may expand the use of UWB communication technology.

The April 22 Report and Order requires that UWB pulses, or signals occupy greater than 20% fractional bandwidth or 500 megahertz, whichever is smaller. Fractional bandwidth is defined as 2 times the difference between the high and low 10 dB cutoff frequencies divided by the sum of the high and low 10 dB cutoff frequencies. Specifically, the fractional bandwidth equation is:

$$Fractional Bandwidth = 2 \frac{{f}_{h} - {f}_{l}}{{f}_{h} + {f}_{l}}$$

where fₕ is the high 10 dB cutoff frequency, and fₗ is the low 10 dB cutoff frequency.

Stated differently, fractional bandwidth is the percentage of a signal's center frequency that the signal occupies. For example, a signal having a center frequency of 10 MHz, and a bandwidth of 2 MHz (i.e., from 9 to 11 MHz), has a 20% fractional bandwidth. That is, center frequency, f_{c}=(fₕ+fₗ)/2

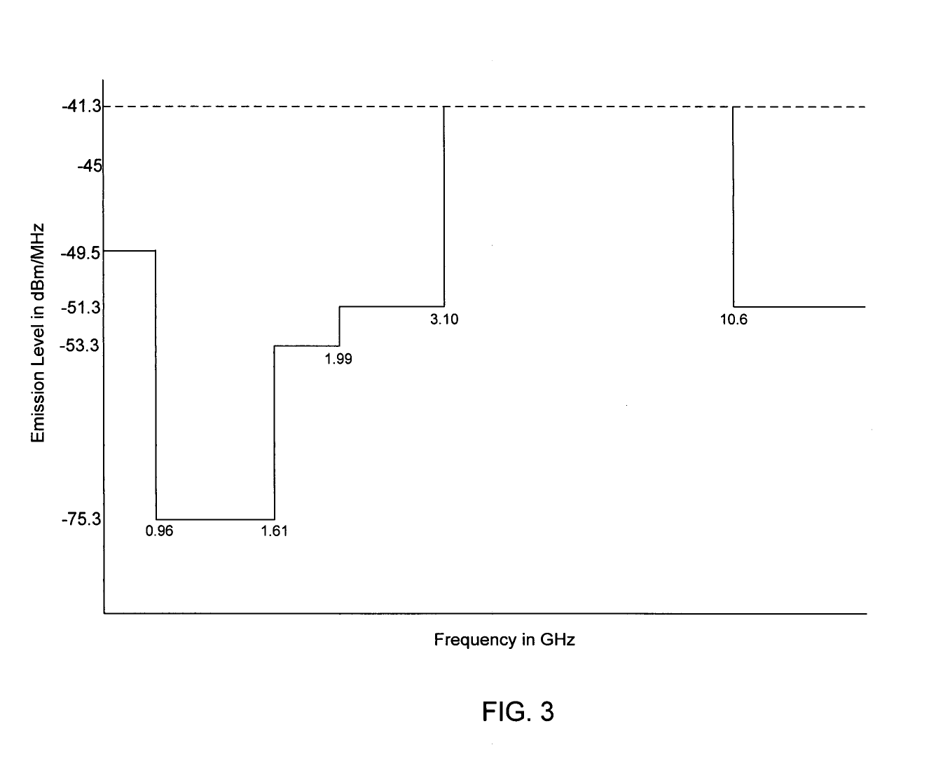

FIG. 3 illustrates the ultra-wideband emission limits for indoor systems mandated by the April 22 Report and Order. The Report and Order constrains UWB communications to the frequency spectrum between 3.1 GHz and 10.6 GHz, with intentional emissions to not exceed −41.3 dBm/MHz. The report and order also established emission limits for hand held UWB systems, vehicular radar systems, medical imaging systems, surveillance systems, through-wall imaging systems, ground penetrating radar and other UWB systems. It will be appreciated that the invention described herein may be employed indoors, and/or outdoors, and may be fixed, and/or mobile.

Communication standards committees associated with the International Institute of Electrical and Electronics Engineers (IEEE) are considering a number of ultra-wideband (UWB) wireless communication methods that meet the constraints established by the FCC. One UWB communication method may transmit UWB pulses that occupy 500 MHz bands within the 7.5 GHz FCC allocation (from 3.1 GHz to 10.6 GHz). In one embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of this communication method, an Inverse Fast Fourier Transform (IFFT) is performed on parallel data to produce 122 carriers, each approximately 4.125 MHz wide. In this embodiment, also known as Orthogonal Frequency Division Multiplexing (OFDM), the resultant UWB pulse, or signal is approximately 506 MHz wide, and has a 242 nanosecond duration. It meets the FCC rules for UWB communications because it is an aggregation of many relatively narrow band carriers rather than because of the duration of each pulse.

Another UWB communication method being evaluated by the IEEE standards committees comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Yet another UWB communication method being evaluated by the IEEE standards committees comprises transmitting a sequence of pulses that may be approximately 0.7 nanoseconds or less in duration, and at a chipping rate of approximately 1.4 giga pulses per second. The pulses are modulated using a Direct-Sequence modulation technique, and is called DS-UWB. Operation in two bands is contemplated, with one band is centered near 4 GHz with a 1.4 GHz wide signal, while the second band is centered near 8 GHz, with a 2.8 GHz wide UWB signal. Operation may occur at either or both of the UWB bands. Data rates between about 28 Megabits/second to as much as 1,320 Megabits/second are contemplated.

Thus, described above are three different methods of ultra-wideband (UWB) communication. Each method may also include a common signaling mode, or protocol, that will allow devices employing different UWB communication methods to communicate with each other.

For example, one embodiment of the present invention comprises communication system that comprises hybrid communication devices that can transmit and/or receive using any one of the above-described UWB communication methods. The signals, or pulses comprising each UWB communication method may be transmitted alternatively or consecutively.

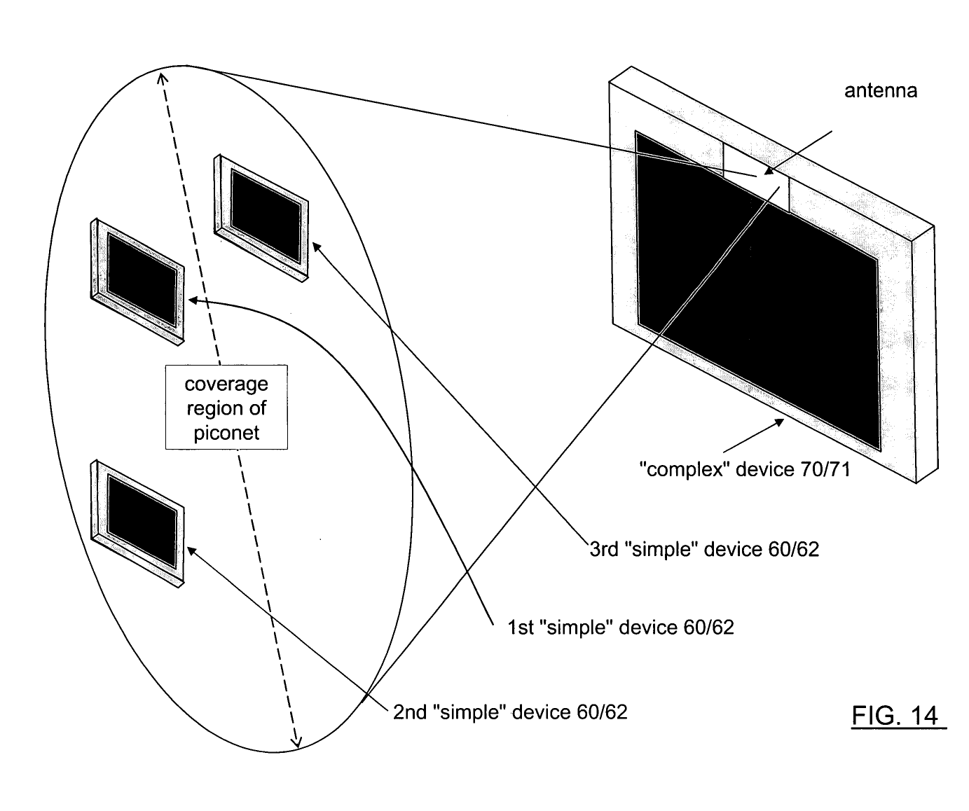

An alternative embodiment of the present invention may comprise a communication system that includes both “complex” and “simple” communication devices. A “complex” hybrid communication device can transmit and/or receive using any one of the above-described UWB communication methods, and may also include the ability to transmit and receive conventional substantially continuous sinusoidal communication methods, such as 802.11a, or other narrowband radio frequency technology. A “simple” communication device may employ only one of the above-described UWB communication methods, or may use a conventional, substantially continuous sinusoidal communication method. In this communication system, the “simple” device can communicate with the “complex” device, and vice-versa. One embodiment of this communication system is illustrated in FIG. 14.

With regard to communication through wire media, ultra-wideband communication is not limited by the above-mentioned FCC constraints. Wire media as defined herein may include an optical fiber ribbon, a fiber optic cable, a single mode fiber optic cable, a multi-mode fiber optic cable, a twisted pair wire, an unshielded twisted pair wire, a plenum wire, a PVC wire, a coaxial cable, and an electrically conductive material.

In wire media applications, ultra-wideband (UWB) pulse durations may range from about 10 picoseconds to about a microsecond. Moreover, the power (sampled at a single frequency) of UWB pulse sequences transmitted though wire media may range from about +30 dBm to about −140 dBm.

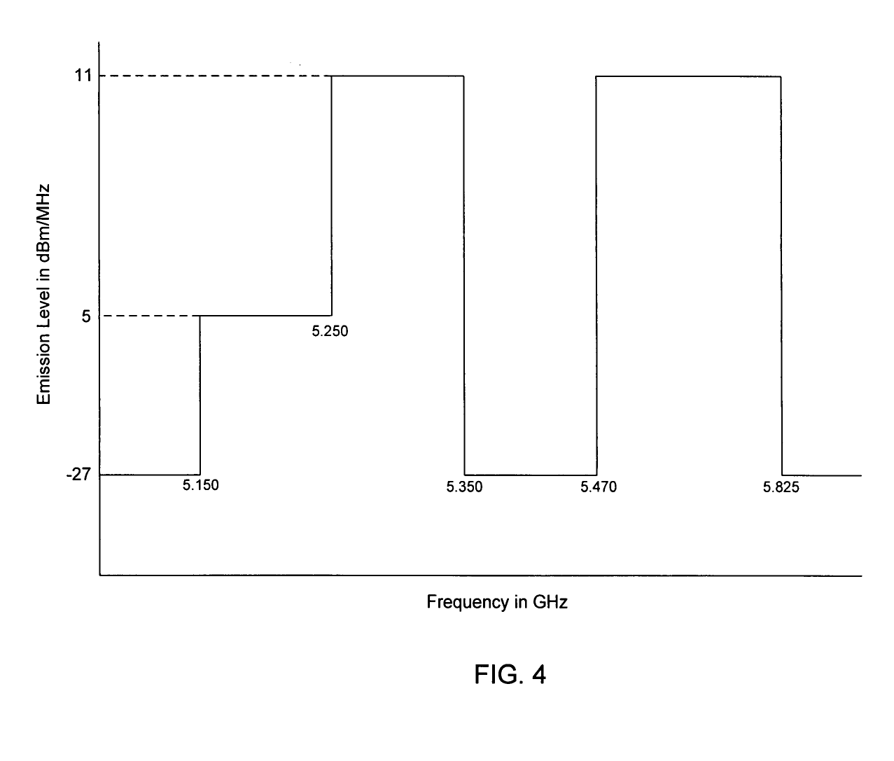

In addition, the FCC, in their Report & Order of Nov. 18, 2003 (ET Docket 03-122) has allocated additional radio frequency spectrum at higher emission levels for Unlicensed National Information Infrastructure (U-NII) devices in the 5-gigahertz range. As shown in FIG. 4, this new allocation allows higher emission levels in bands between 5.15 GHz and 5.825 GHz. The ability to transmit at higher emission levels has many benefits.

One embodiment of the present invention comprises a method of transmitting both ultra-wideband pulses, and conventional carrier wave signals. A device constructed according to this embodiment may include a transmitter configured to transmit both carrier wave signals and UWB pulses. The carrier wave signals and the UWB pulses may be transmitted substantially simultaneously, or they may be transmitted consecutively. The transmitter may include a carrier wave transmitter element that enables carrier wave signals to be transmitted. A single antenna may be used for transmitting both the carrier wave signals and the UWB pulses, or multiple antennas may be employed.

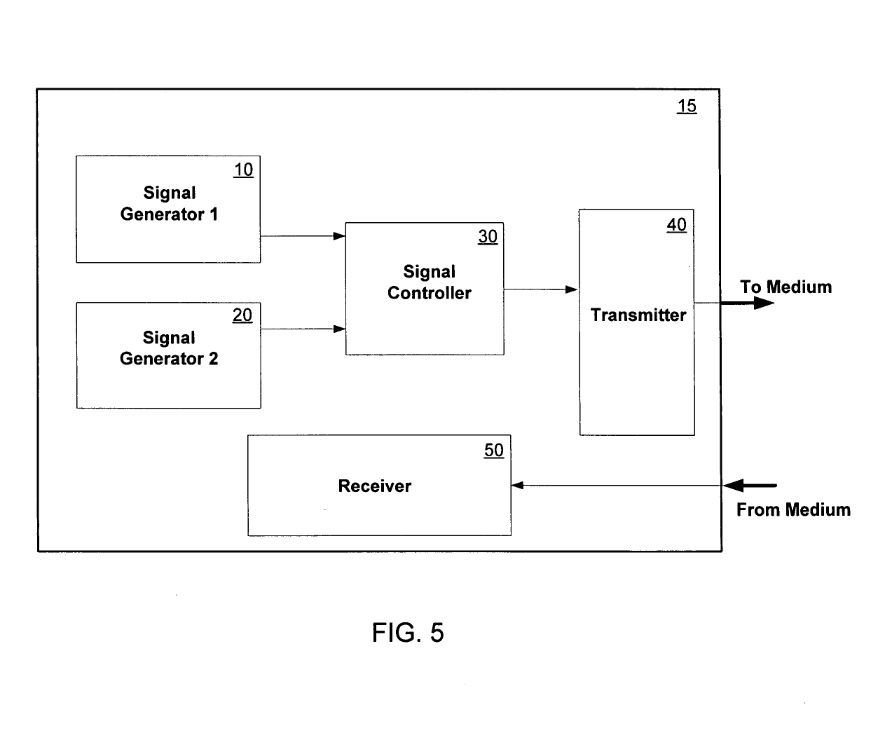

Referring now to FIG. 5, a functional block diagram of a hybrid communication device 15 constructed according to one embodiment of the present invention is illustrated. The communication device 15 comprises a first signal generator 10, a second signal generator 20, a signal controller 30, a transmitter 40, and a receiver 50. The hybrid communication device 15 may also include several other components (not shown), including a controller (such as a microprocessor and/or a finite state machine), a digital signal processor, an analog coder/decoder, a waveform generator, an encoder, static and dynamic memory, data storage devices, an amplifier, an interface, one or more devices for data access management, and associated cabling and electronics. One or more of the above-listed components may be co-located or they may be separate devices, and the hybrid communication device 15 may include some, or all of these components, other necessary components, or their equivalents. The controller may include error control, and data compression functions. The analog coder/decoder may include an analog to digital conversion function and vice versa. The data access management device or devices may include various interface functions for interfacing to wire media such as phone lines and coaxial cables. Alternative embodiments of the hybrid communication device 15 may employ hard-wired circuitry used in place of, or in combination with software instructions. Thus, embodiments of the hybrid communication device 15 are not limited to any specific combination of hardware or software.

Signal generator 10 may generate a plurality of ultra-wideband (UWB) pulses and may further comprise a data modulator, which encodes data onto the UWB pulses. The UWB pulses may be either “multi-band” UWB pulses, Direct-Sequence modulated UWB pulses using the DS-UWB format as described above, or alternatively they may occupy a single portion of the available radio frequency spectrum. The UWB pulses generated by signal generator 10 may comprise a plurality of separate pulses or alternatively they may be aggregated to form a conventional carrier wave communication signal.

Signal generator 20 is configured to generate a non-UWB signal and may include a data modulator, which encodes data onto the non-UWB signal. In one embodiment, the signal generator 20 generates a conventional carrier wave signal. This carrier wave signal may be spread by conventional spread spectrum techniques, from 10's of kilohertz to about 350 MHz wide (or, in the DS-UWB method, to 1.4 GHz), or alternatively, the carrier wave signal may only occupy a single narrow band radio frequency channel. In another embodiment, the signal generator 20 may generate a plurality of electromagnetic pulses that do not meet the current FCC requirements for ultra-wideband communications. In this embodiment, the pulse durations may be longer than 2 nanoseconds, thereby occupying less than 500 MHz of frequency spectrum. For example, the signal generator may generate a 3 nanosecond pulse, which occupies about 333 MHz of frequency spectrum. These pulses may have a center frequency of about 5.5 GHz, and a bandwidth ranging from about 5.333 GHz to about 5.667 GHz. Thus, this pulse has only about a 333 MHz bandwidth and therefore is not an ultra-wideband pulse, as currently defined by the FCC.

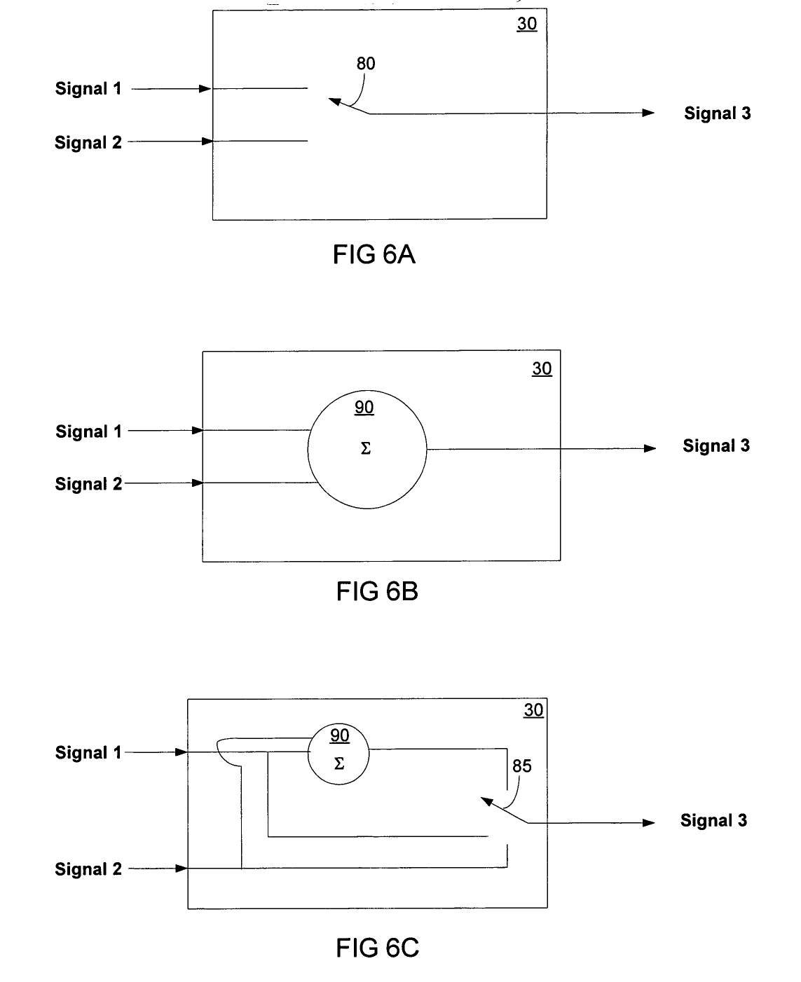

Signal controller 30 takes the output of signal generator 10 and signal generator 20 and generates a signal for transmission through either a wire, or wireless medium. As shown in FIG. 6A, signal controller 30 may comprise a switch 80 that may be controlled to pass either Signal 1, generated by signal generator 10, or Signal 2, generated by signal generator 20. Alternatively, as shown in FIG. 6B, signal controller 30 may comprise summer 90 which sums Signal 1 and Signal 2 to form Signal 3. In another embodiment, shown in FIG. 6C, signal controller 30 may comprise a summer 90 and a multi-position switch 85. The summer 90 adds the Signal 1 and Signal 2 and provides this additive signal to one input of the multi-position switch 85. Multi-position switch 85 may then select to pass any one of three signals: the summed, or additive signal; the original Signal 1, or the original Signal 2. The chosen signal then becomes Signal 3. The multi-position switch 85 may have Signal 1, Signal 2, and the sum of Signal 1 and Signal 2 as inputs. In other embodiments of the hybrid communication device 15 there may be additional signal generators 10 and 20. In those embodiments, the multi-position switch 85 and potentially the summers 90 may have additional inputs.

As shown in FIG. 5, the hybrid communication device 15 includes a transmitter 40 and a receiver 50 configured to transmit and receive signals from a medium, whether wire, or wireless. In one embodiment of the present invention, as discussed above, Signal 3 that is output by the signal controller 30 comprises both UWB pulses, and a carrier wave, or narrow band signal. Transmitter 40 transmits this combined signal through the communication medium. The receiver 50 of another hybrid communication device 15 receives this combined signal. One feature of this type of combined communication signal is that it can be used to provide synchronization between the receiver 50 and the transmitter 40. In this embodiment, the carrier wave signal may carry no data. Alternatively, in another embodiment, the carrier wave signal may include data modulation that contains information. In yet another embodiment Signal 3, output by the signal controller 30 may be comprised of non-UWB pulses, such as a plurality of electromagnetic pulses that do not meet current FCC rules for access to the UWB frequency band, and pulses that do meet the current FCC rules for UWB communication. Both types of pulses may be modulated to contain information, and the receiver 50 may demodulate data from both portions of the received signal.

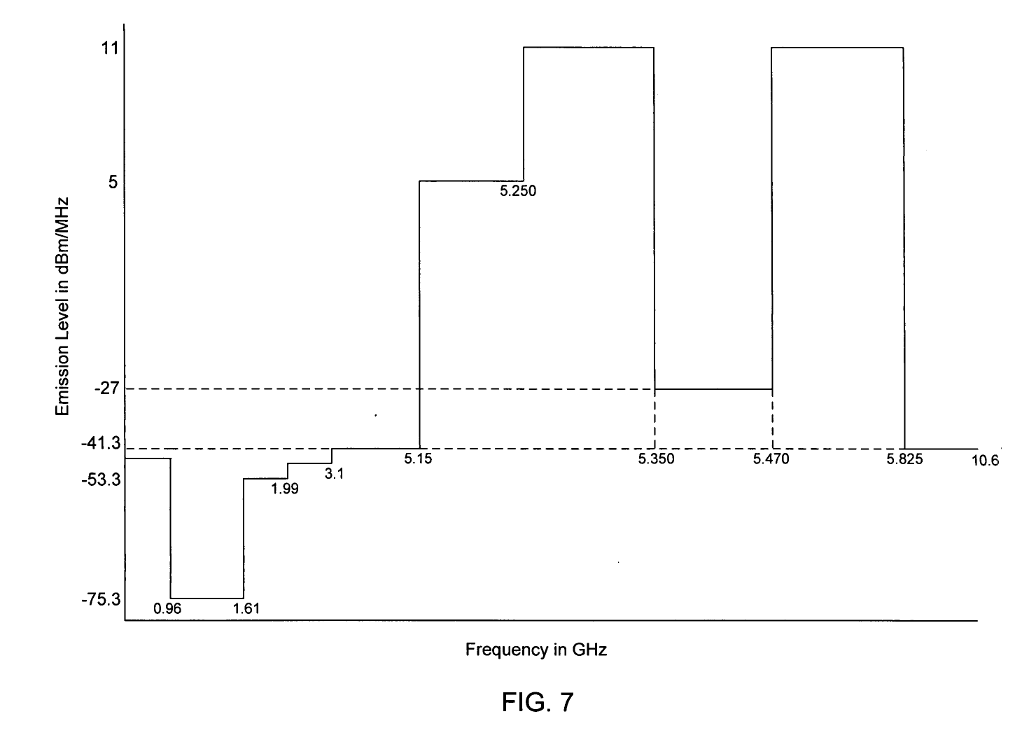

Referring now to FIG. 7, a combination frequency spectrum chart is illustrated. The FIG. 7 chart includes both frequency spectrum charts illustrated in FIGS. 3 and 4. The FIG. 7 chart shows the emission limits in dBm/MHz for wireless signals as established by the FCC Report and Order of Apr. 22, 2002, and Nov. 18, 2003, as discussed above.

One feature of the present invention is that a hybrid communication device 15 may transmit and receive ultra-wideband (UWB) pulses between 3.1 GHz and 10.6 GHz at up to −41.3 dBm/MHz. The same hybrid communication device 15 may also transmit electromagnetic pulses less than 500 MHz in bandwidth anywhere between the frequencies of 5.15 GHz and 5.825 GHz at up to −27 dBm/MHz. In addition, a hybrid communication device 15 may also transmit electromagnetic pulses less than 500 MHz in bandwidth anywhere between the frequencies of 5.15 GHz and 5.25 GHz at up to 5 dBm/MHz. Finally, a hybrid communication device 15 may also transmit electromagnetic pulses less than 500 MHz in bandwidth anywhere between the frequencies of 5.25 GHz and 5.35 GHz and the frequencies of 5.470 and 5.825 at up to 11 dBm/MHz.

Generally, the above-mentioned electromagnetic pulses will have a duration of greater than 2 nanoseconds, which results in a pulse that occupies less than 500 MHz of frequency spectrum. Alternatively, electromagnetic pulses less than 2 nanoseconds may be employed, and filters may be used to limit the occupied frequency spectrum to less than 500 MHz.

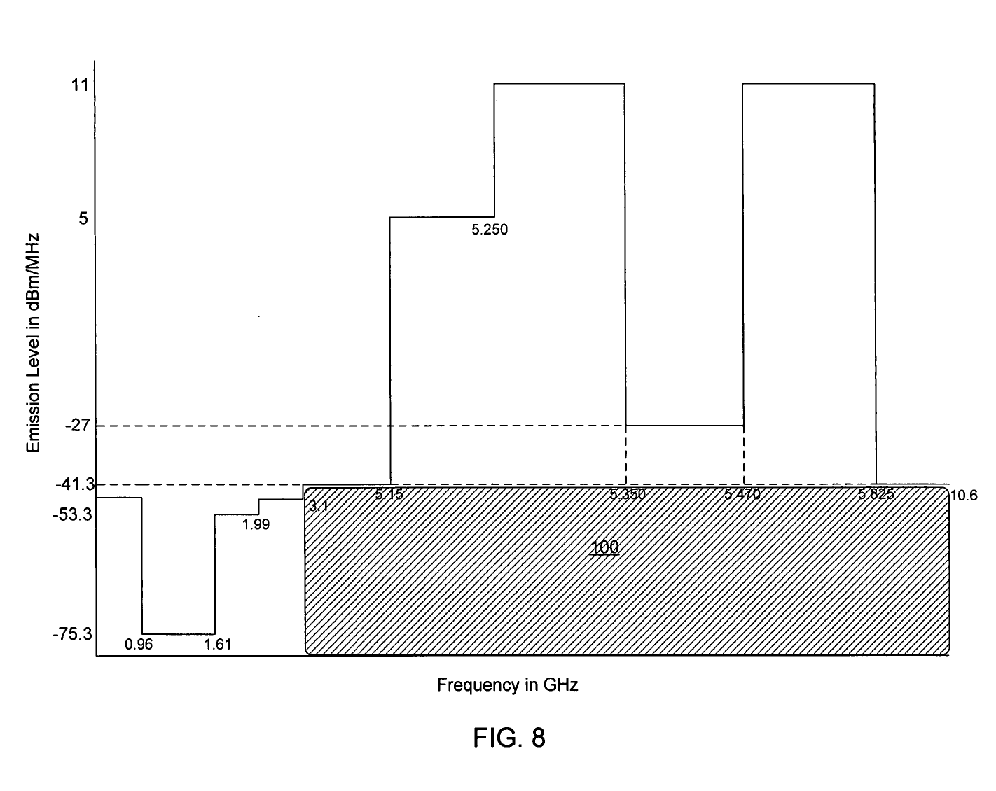

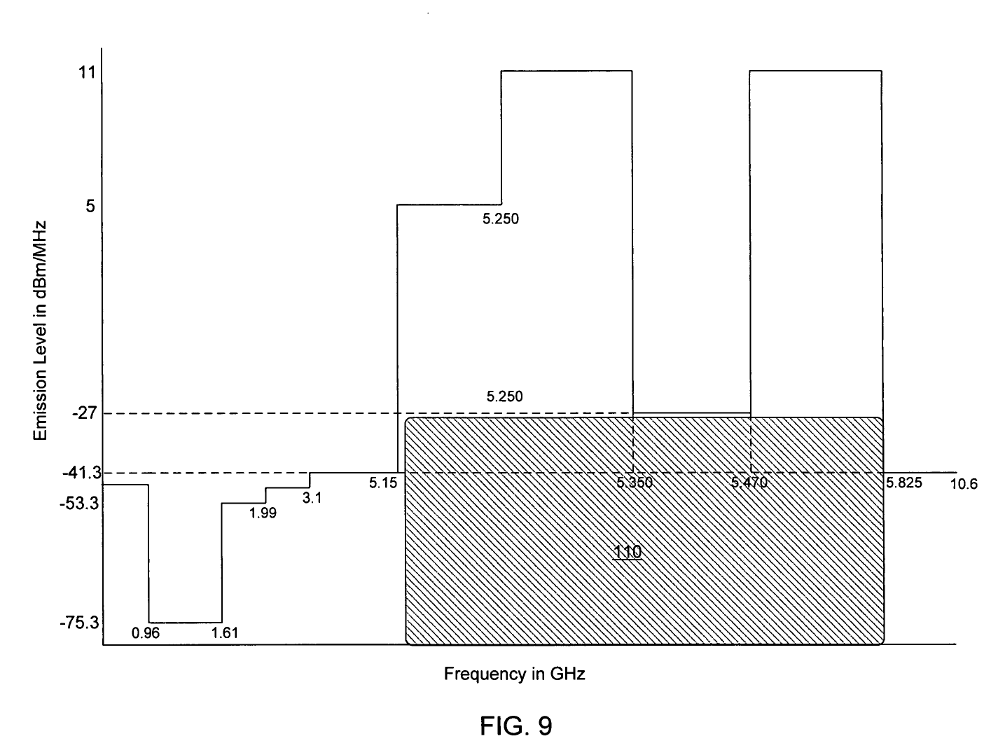

For example, as shown in FIG. 8, ultra-wideband (UWB) pulses may be transmitted anywhere between 3.1 GHz and 10.6 GHz frequency band 100 at up to −41.3 dBm/MHz by the hybrid communication device 15. In a preferred embodiment, the UWB pulses may only occupy a range from about 3.1 GHz to about 5.1 GHz of the frequency band 100. It will be appreciated that the UWB pulses may occupy multiple 500 MHz portions of the frequency band 100, which is the “multi-band” communication method described above. Under the current FCC limitations the UWB pulses should occupy a minimum frequency spectrum, or band of 500 MHz.

FIG. 9 illustrates another communication method that may be employed by the hybrid communication device 15 in the 5.15 GHz to 5.825 GHz frequency band 110. In this embodiment, electromagnetic pulses that occupy less than 500 MHz of the frequency band 110 may be transmitted and received. Generally, these pulses will have a duration that is greater than 2 nanoseconds. Under current FCC guidelines, these electromagnetic pulses may be transmitted at up to −27 dBm/MHz.

Alternatively, the hybrid communication device 15 may transmit conventional carrier wave signals in the frequency band 110. In this embodiment, the communications signal may be either a single frequency tone (i.e., a substantially continuous narrowband carrier wave) or it may be a substantially continuous carrier wave signal that has been spread to occupy a bandwidth that is larger than a single frequency.

In yet another communication method, the hybrid communication device 15 may transmit conventional carrier wave signals in the frequency band 110, and simultaneously, transmit electromagnetic pulses that have been superimposed onto the conventional carrier wave signals. Data may be recovered from both the carrier wave signals and the pulses.

Under the current FCC rules, within frequency band 110, a conventional carrier wave signal should be transmitted at −27 dBm/MHz. At this new allowable emission, hybrid communication devices 15 may be able to communicate at distances greater than communication distances achievable by using only ultra-wideband pulses transmitted at −41.3 dBm/MHz. In addition to providing greater communication distances, a conventional carrier wave signal may be employed to provide timing synchronization between two communicating hybrid communication devices 15.

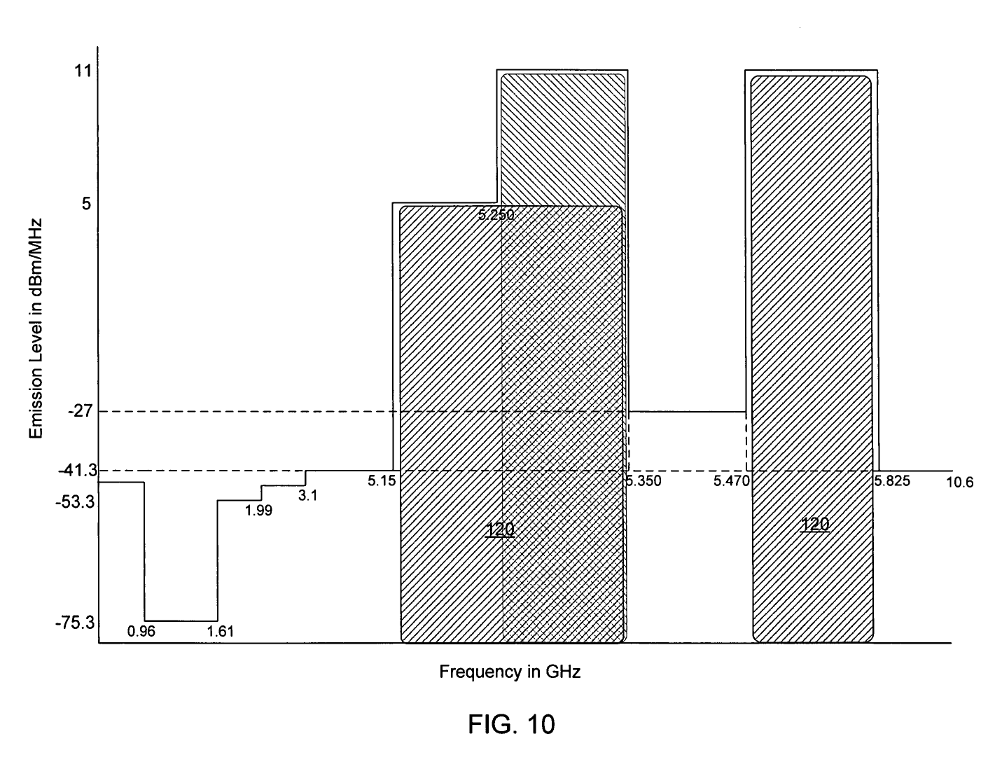

FIG. 10 illustrates another communication method that may be employed by the hybrid communication device 15 in the 5.15 GHz to 5.35 GHz and the 5.470 GHz to 5.825 GHz frequency band 120. In this embodiment, electromagnetic pulses that occupy less than 500 MHz of the frequency band 120 may be transmitted and received. Generally, these pulses will have a duration that is greater than 2 nanoseconds. Under current FCC guidelines, these electromagnetic pulses may be transmitted at up to 11 dBm/MHz. Specifically, under the current FCC rules, one portion of the frequency band 120, between 5.15 GHz to 5.35 GHz, allows non-ultra-wideband communications at up to 5 dBm/MHz. A narrower portion of the same band, from 5.25 GHz to 5.35 GHz, allows non-ultra-wideband communications at up to 11 dBm/MHz. In addition, another segment of frequency band 120, from 5.470 GHz to 5.825 GHz, allows non-ultra-wideband communications at up to 11 dBm/MHz.

Communication methods in frequency band 120 may be similar to that described above in connection with FIG. 9. That is, conventional carrier wave signals may be transmitted, as well as discrete electromagnetic pulses that occupy less than 500 MHz of frequency spectrum.

As described above, the hybrid communication device 15 is capable of transmitting and receiving using different communication methods: ultra-wideband pulses, and conventional carrier wave signals. Generally, this capability requires the hybrid communication device 15 to employ a common Media Access Control (MAC) while still supporting different “physical layers” (PHY). In one embodiment, the hybrid communication device 15 can readily co-exist with other existing wireless communication systems that operate in the license-free frequency bands. In yet another embodiment, the hybrid communication device 15 can operate in a mode where at least one version of the hybrid communication device 15 can be a “complex” device capable of supporting at least two PHYs, and another version of the hybrid communication device 15 comprises “simple” units that support at least one PHY. In this embodiment, interoperability among PHYs is enabled via the “complex” device, while simplicity, low cost and low power consumption is achieved in the “simple” devices.

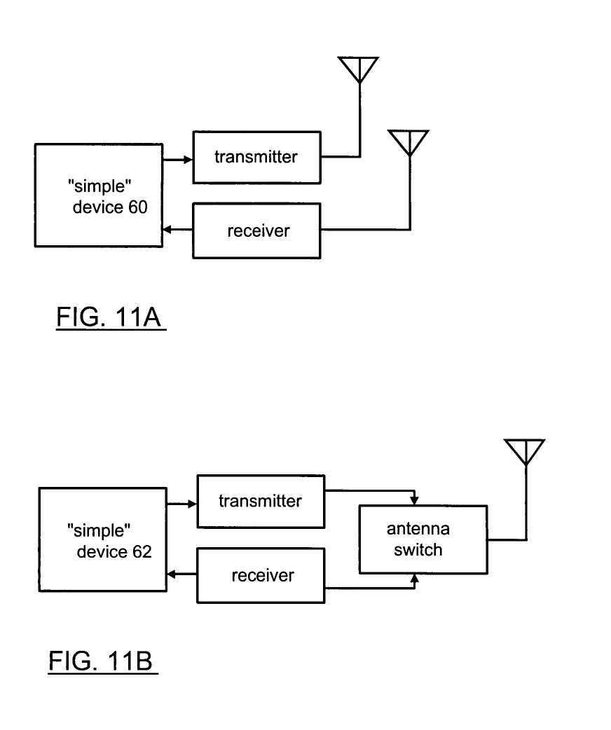

Referring now to FIGS. 11-13, various embodiments of the hybrid communication device 15 are illustrated. As shown in FIGS. 11A-B, two embodiments of a hybrid communication device comprise a “simple” device 60, and a “simple” device 62 that includes an antenna switch. “Simple” devices 60 and 62 contain only one type of “physical layer” (PHY). A PHY is the part of a communication device that produces communication pulses, or signals. That is, it comprises a transmitter, a receiver, an analog to digital converter, and vice-versa, a modulator, a demodulator, and other components necessary for communication, as described above in connection with the construction of the hybrid communication device 15.

Thus, a hybrid communication device 15 uses its PHY to transmit pulses, or signals, which are transmitted according to communication rules established by a Media Access Control (MAC) layer. The MAC layer may be software, firmware, hardware, or a combination of any of the three. That is, the PHY generates the pulses, or signals, and the MAC determines the rules that different communicating devices use to transfer information to each other.

One embodiment hybrid communication device 15 may include multiple PHYs, with one, or more, MAC(s). For example, as discussed above, currently there are three different UWB communication methods: the DS-UWB method; the multi-band UWB method; and the UWB communication method that employs a substantial portion of the available allocated frequency spectrum. A hybrid communication device 15 may include at least two different PHYs, and one, or more, MAC(s), that may contain a common signaling method, or protocol. A communication system constructed according to one embodiment of the present invention may use hybrid communication devices 15, each employing at least two PHYs, and allow communication between devices 15 that are using different PHYs. It will be appreciated that other UWB, and non-UWB communication methods not yet proposed may also be employed by the present invention.

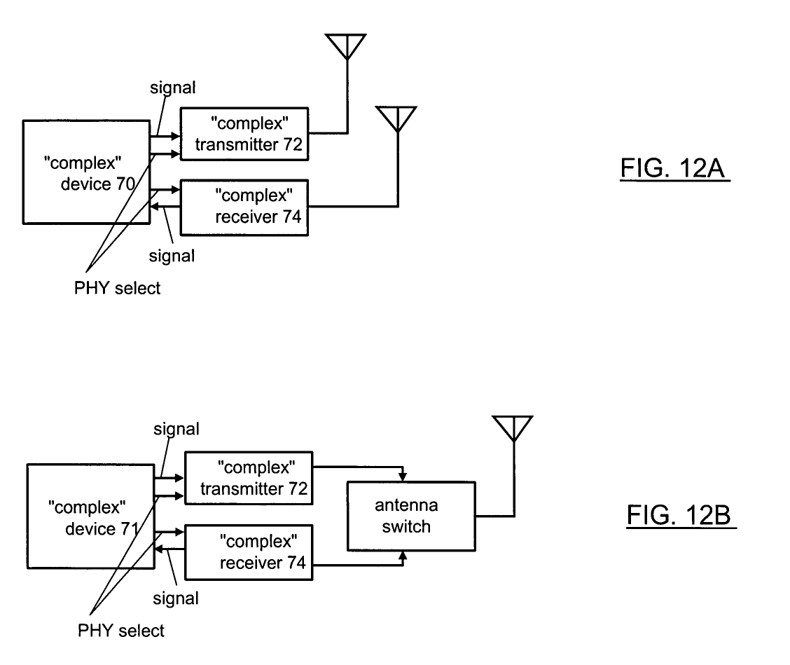

Referring now to FIGS. 11A-B, “simple” communication devices 60 and 62 are illustrated. The “simple” devices 60, 62 may be useful in portable low-power consuming devices, such as sensors, and other types of devices, as their PHY may be a low-data rate PHY. However, “complex” device 70 and “complex” device 71, with an antenna switch, shown in FIGS. 12A-B, may have a PHY that is capable of high-data rate communication, and may be suitable in fixed, or mobile applications where it can also act as a piconet controller mediating access among at least two “simple” devices 60, 62. Generally, a piconet is a group of two or more devices operating with a common MAC, which are associated in some manner.

In one method of communication of the present invention, a high data capacity two-way wireless, or wire communication system is deployed using a common MAC layer while still supporting a variety of different PHYs. As discussed above, this communication system may comprise hybrid communication devices 15, each employing at least two PHYs, thereby allowing communication between devices 15 that are using different PHYs.

This communication method can readily coexist with other existing wireless communication systems that operate in the license-free bands, such as the frequency bands 110 and 120 discussed with reference to FIGS. 9 and 10. It will be appreciated that other radio frequency spectrum, or bands, such as the 2.4 GHz band may be employed by the present invention.

Again referring to FIGS. 1A-B and 12A-B, the “simple” devices 60, 62 may include only one PHY, but other embodiments may have two PHYs. The “complex” devices 70, 71 may have at least two PHYs, and both the “simple” and “complex” devices 60, 62, 70, and 71 may have a MAC layer that mediates among the at least two PHYs.

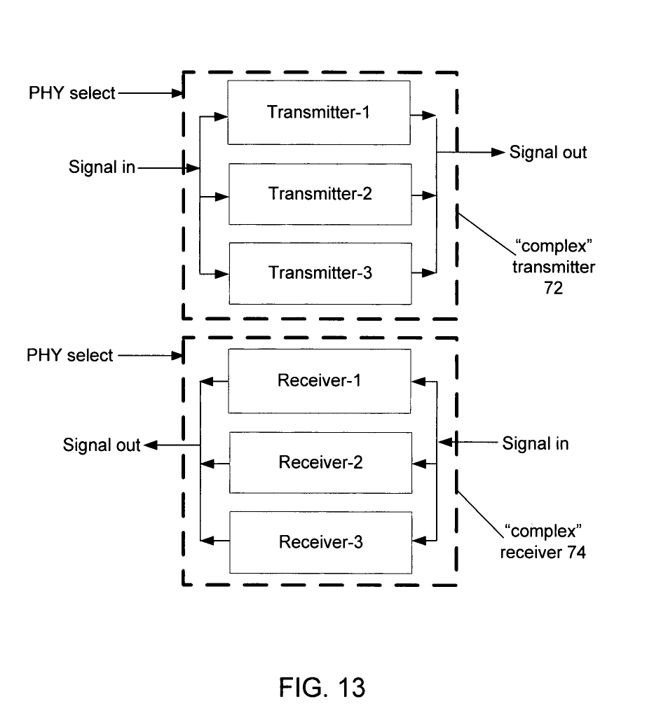

As shown in FIGS. 12A-B, the “complex” devices 70, 71 include a “complex” transmitter 72 and a “complex” receiver 74. Referring now to FIG. 13, the “complex” transmitter 72 and the “complex” receiver 74 include different transmitters 1-3 and receivers 1-3 that a constructed to the requirements of the different PHYs. For example, as discussed above, the different PHY's or communication methods, may include: the DS-UWB method; the multi-band UWB method; the UWB communication method that employs a substantial portion of the available allocated frequency spectrum, or other UWB communication methods not yet proposed. It will be appreciated that a “complex” transmitter 72 and a “complex” receiver 74 may only include one transmitter and one receiver element, which may operate as one, or more PHYs. In one embodiment of the present invention, the “complex” device 70, or “complex” device 71 may be included within a version of the hybrid communication device 15.

The hybrid communication device 15, the “simple” devices 60, 62 as well as the “complex” devices 70 and 71 may include: a phone, a personal digital assistant, a portable computer, a laptop computer, a desktop computer, a mainframe computer, video monitors, computer monitors, and any other device that uses the U-NII frequency spectrum, or the ultra-wideband frequency spectrum, both as defined above.

Referring now to FIG. 14, a communication method according to one embodiment of the present invention is illustrated. “Complex” device 70 comprises a plasma, HDTV, or other type of display unit. Several, in this case three (1^{st}, 2^{nd}, and 3^{rd}), “simple” devices 60 are shown operating with the “complex” device 70. In this illustrative example, the “simple” devices may each use different PHYs, with the “complex” device 70 operating as a piconet controller, thereby controlling communication among all the devices in the piconet. It will be appreciated that any device 60 or 70 in a piconet may be a piconet controller. For example, the 3^{rd} “simple” device can act as a piconet controller for the other devices in the piconet.

Thus, it is seen that a systems, methods and articles of manufacture are provided for electromagnetic pulse generation suitable for communications in a wired or wireless medium. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

1. A method of communication, the method comprising the steps of:
transmitting a first communication signal comprising a plurality of discrete electromagnetic pulses; and
transmitting a second communication signal comprising a substantially continuous sinusoidal waveform.

2. The method of claim 1, wherein each of the discrete electromagnetic pulses has a duration that ranges between about 10 picoseconds to about 1 microsecond.

3. The method of claim 1, wherein the second communication signal comprising the substantially continuous sinusoidal waveform has a duration that ranges between about 1 microsecond to about 1 millisecond.

4. The method of claim 1, wherein each of the plurality of discrete electromagnetic pulses occupies less than 500 megahertz of a radio frequency spectrum.

5. The method of claim 1, wherein the substantially continuous sinusoidal waveform has less than a 20% fractional bandwidth.

6. The method of claim 1, wherein the substantially continuous sinusoidal waveform has a center frequency that ranges between about 2 gigahertz to about 6 gigahertz.

7. The method of claim 1, wherein each of the discrete electromagnetic pulses has a power that can range between about +30 dBm to about −60 dBm, as measured at a single frequency.

8. The method of claim 1, wherein the first communication signal and the second communication signal are transmitted substantially simultaneously.

9. The method of claim 1, wherein the first communication signal and the second communication signal are transmitted consecutively.

10. The method of claim 1, wherein the first communication signal comprises a plurality of discrete electromagnetic pulses each having a bandwidth less than 500 MHz and transmitted at a radio frequency ranging between 5.15 GHz and 5.825 GHz at up to −27 dBm/MHz.

11. The method of claim 1, wherein the first communication signal comprises a plurality of discrete electromagnetic pulses each having a bandwidth less than 500 MHz and transmitted at a radio frequency ranging between 5.15 GHz and 5.25 GHz at up to 5 dBm/MHz.

12. The method of claim 1, wherein the first communication signal comprises a plurality of discrete electromagnetic pulses each having a bandwidth less than 500 MHz and transmitted at a radio frequency ranging between 5.25 GHz and 5.35 GHz and between 5.470 and 5.825 at up to 11 dBm/MHz.

13. The method of claim 1, wherein the first communication signal and the second communication signal are transmitted wirelessly or through a wire medium.

14. A method of communication, the method comprising the steps of:
transmitting a plurality of ultra-wideband pulses; and
transmitting a carrier wave.

15. The method of claim 14, wherein each of the ultra-wideband pulses has a duration that ranges between about 10 picoseconds to about 2 nanoseconds.

16. The method of claim 14, wherein the carrier wave has less than a 20% fractional bandwidth.

17. The method of claim 14, wherein the carrier wave occupies a portion of a radio frequency spectrum ranging between about 10 kilohertz to about 355 megahertz.

18. The method of claim 14, wherein the carrier wave has a center frequency that ranges between about 2 gigahertz to about 6 gigahertz.

19. The method of claim 14, wherein the plurality of ultra-wideband pulses and the carrier wave are transmitted substantially simultaneously.

20. The method of claim 14, wherein the plurality of ultra-wideband pulses and the carrier wave are transmitted consecutively.

21. The method of claim 14, wherein the plurality of ultra-wideband pulses and the carrier wave are transmitted wirelessly or through a wire medium.

22. A communication device comprising:
a first signal generator structured to generate a first communication signal comprising a plurality of discrete electromagnetic pulses;
a second signal generator structured to generate a second communication signal comprising a substantially continuous sinusoidal waveform;
a signal controller structured to receive the first and second communication signals; and
a transmitter structured to transmit a signal received from the signal controller.

23. The communication device of claim 22, wherein each of the discrete electromagnetic pulses has a duration that ranges between about 10 picoseconds to about 1 microsecond.

24. The communication device of claim 22, wherein the substantially continuous sinusoidal waveform has less than a 20% fractional bandwidth.

25. The communication device of claim 22, wherein each of the plurality of discrete electromagnetic pulses occupies less than 500 megahertz of a radio frequency spectrum.

26. The communication device of claim 22, wherein the signal controller comprises a summer that adds the plurality of discrete electromagnetic pulses and the substantially continuous sinusoidal waveform thereby generating the signal.

27. The communication device of claim 22, wherein the signal controller comprises a switch that passes either the plurality of discrete electromagnetic pulses or the substantially continuous sinusoidal waveform to the transmitter.

28. The communication device of claim 22, wherein the signal is transmitted wirelessly or through a wire medium.

29. A method of communication, the method comprising the steps of:
generating a first communication signal at a first radio frequency band;
generating a second communication signal at a second radio frequency band;
modulating data onto the first and second communication signals;
generating a third communication signal from the first and second communication signals; and
transmitting the third communication signal.

30. The method of claim 29, wherein the first communication signal comprises a plurality of ultra-wideband pulses.

31. The method of claim 29, wherein the first communication signal comprises a plurality of discrete electromagnetic pulses, with each pulse having a duration that ranges from about 10 picoseconds to about 1 microsecond.

32. The method of claim 29, wherein the first communication signal comprises a plurality of ultra-wideband pulses that occupy a radio frequency spectrum that ranges between about 500 megahertz to about 7.5 gigahertz.

33. The method of claim 29, wherein the first communication signal comprises a plurality of ultra-wideband pulses having a center frequency that ranges between about 3.1 gigahertz to about 10.6 gigahertz.

34. The method of claim 29, wherein the second communication signal comprises a plurality of electromagnetic pulses that occupy a radio frequency spectrum that ranges between about 100 megahertz to about 350 megahertz.

35. The method of claim 29, wherein the second communication signal comprises a substantially continuous sinusoidal waveform that has less than a 20% fractional bandwidth.

36. The method of claim 29, wherein the second communication signal comprises a carrier wave that has a center frequency that ranges between about 2 gigahertz to about 6 gigahertz.

37. The method of claim 29, wherein the third communication signal is transmitted wirelessly or through a wire medium.

38. The method of claim 29, wherein the third communication signal comprises a sum of the first communication signal and the second communication signal.

39. A method of communication, the method comprising the steps of:
transmitting a first group of discrete electromagnetic pulses, with each pulse having a fractional bandwidth greater than 20%; and
transmitting a second group of discrete electromagnetic pulses, with each pulse having a fractional bandwidth less than 20%.

40. The method of claim 39, wherein each of the discrete electromagnetic pulses has a duration that ranges between about 10 picoseconds to about 1 microsecond.

41. The method of claim 39, wherein each of the plurality of discrete electromagnetic pulses in the first group occupies more than 500 megahertz of a radio frequency spectrum.

42. The method of claim 39, wherein each of the plurality of discrete electromagnetic pulses in the second group occupies less than 500 megahertz of a radio frequency spectrum.

43. The method of claim 39, wherein each group of discrete electromagnetic pulses has a power that can range between about +30 dBm to about −60 dBm, as measured at a single frequency.

44. The method of claim 39, wherein the first group and second group of discrete electromagnetic pulses are transmitted substantially simultaneously.

45. The method of claim 39, wherein the first group and second group of discrete electromagnetic pulses are transmitted consecutively.

46. The method of claim 39, wherein the first group and second group of discrete electromagnetic pulses are transmitted wirelessly or through a wire medium.

47. A method of communication, the method comprising the steps of:
transmitting a first communication signal using a first ultra-wideband communication method; and
transmitting a second communication signal using a second ultra-wideband communication method.

48. The method of claim 47, wherein the first and second ultra-wideband communication methods are selected from a group consisting of: a multi-band communication method, a direct-sequence communication method, an orthogonal frequency division multiplexing method, and a method comprising transmitting a plurality of electromagnetic pulses, with each pulse having a duration that ranges between about 130 picoseconds to about 2 nanoseconds.
